(19) United States
(12) Patent Application Publication
(10) Pub. No.: US 2026/0231853 A1
(43) Pub. Date: Aug. 13, 2026

(54) AIR STREAM SELECTOR

(71) Applicant: VADERSTAD INDUSTRIES INC., Langbank (CA)

(72) Inventors: Jordan ESAU, Moosomin (CA); Gert GILSTRING, Langbank (CA)

(21) Appl. No.: 19/155,888

(22) PCT Filed: Feb. 7, 2024
(86) PCT No.: PCT/CA2024/050145

§ 371 Date: Aug. 12, 2025

Related U.S. Application Data
(60) Provisional application No. 63/485,432, filed on Feb. 16, 2023.

(51) Int. Cl. A01C 7/08; A01C 19/02

(52) U.S. Cl. CPC A01C 7/084; A01C 19/02

(57) ABSTRACT

An air stream selector comprising: a material inlet; a first material outlet chute and a second material outlet chute, the first and second material outlet chutes being in communication with first and second air flow channels, respectively; and an air stream selector drum positioned between the material inlet and the first and second material outlet chutes, the drum being rotatable about an axis and including a channel therethrough, the channel including an inlet end and an outlet end, the outlet end configured to be alignable with only a selected one of the first material outlet chute and the second material outlet chute, while the inlet end remains in communication with the material inlet. The air stream selector may include a processor configured to monitor and command a shaft to selectably align the outlet end and other parts of the air stream selector.

This application claims priority from U.S. provisional application 63/485,432, filed Feb. 16, 2023.

### TECHNICAL AREA

The invention relates to a material valve for controlling an incoming granular material flow to a selected one of multiple material outlets. The invention further relates to an agricultural implement comprising at least one such material valve and a method for controlling a granular material flow to a selected one of the multiple material outlets.

The material valve described herein is used in agricultural implements for feeding granular material, such as seed materials or granular (including powdered) fertilizer or biological inputs, to ground over which the agricultural implement travels. In the agricultural industry, the material valve described herein is generally referred to as an air stream selector.

### BACKGROUND

Modern agricultural implements, such as sowing machines, may include one or more centrally located containers, such as hoppers, for holding granular materials. Granular materials such as seeds or fertilizer are fed from the bottom of these containers, for example, by means of a meter to airstreams flowing through one or more air flow channels, whereby the material is fed by means of the airstreams to a ground engaging tool such as a furrow opener. The air streams can be fed directly from the respective channel to a ground-engaging tool associated with the channel. Alternatively, the material in an air flow channel can be distributed in a distributor to a number of secondary channels that lead to the respective ground-engaging tools.

A material valve, commonly referred to as an air stream selector, is located between the meter and the one or more air flow channels to control the air flow channel into which the granular material is directed.

The development of sowing machines is moving towards ever larger machines. Regardless, it is desirable to be able to feed from a few central containers via a number of primary air flow channels.

It is also desirable to be able to readily change from feeding one type of granular product to another, and to change the airstream into which it is distributed.

Thus, it is desirable to be able to selectively control the air stream selector to control feeding from the hoppers to a plurality of different air flow channels.

### SUMMARY

According to a first aspect, an air stream selector is provided for selectively feeding granular material from a material inlet to one of at least two air flow channels.

In accordance with a broad aspect of the present invention, there is provided an air stream selector comprising: a material inlet; a first material outlet chute and a second material outlet chute, the first and second material outlet chutes being in communication with first and second air flow channels, respectively; and an air stream selector drum positioned between the material inlet and the first and second material outlet chutes, the drum being rotatable about an axis and including a channel therethrough, the channel including an inlet end and an outlet end, the outlet end configured to be alignable with only a selected one of the first material outlet chute and the second material outlet chute, while the inlet end remains in communication with the material inlet.

In accordance with another broad aspect of the present invention, there is provided an agricultural implement comprising: a hopper for granular material; a meter for receiving granular material from the hopper; and the air stream selector of the preceding paragraph in communication with an output of the meter.

In accordance with another broad aspect of the present invention, there is provided a method for distributing granular material in an agricultural implement, the method comprising: passing the granular material from a meter to an air stream selector according to the preceding paragraph, rotating the air stream selector drum about the axis to align the outlet end of the channel with only a selected one of the first material outlet chute and the second material outlet chute and during rotating the inlet end remains in communication with the material inlet.

### BRIEF DESCRIPTION OF THE DRAWINGS

The present invention, both as to its organization and manner of operation, may best be understood by reference to the following description, and the accompanying drawings wherein like reference numerals are used throughout the several views, and in which:

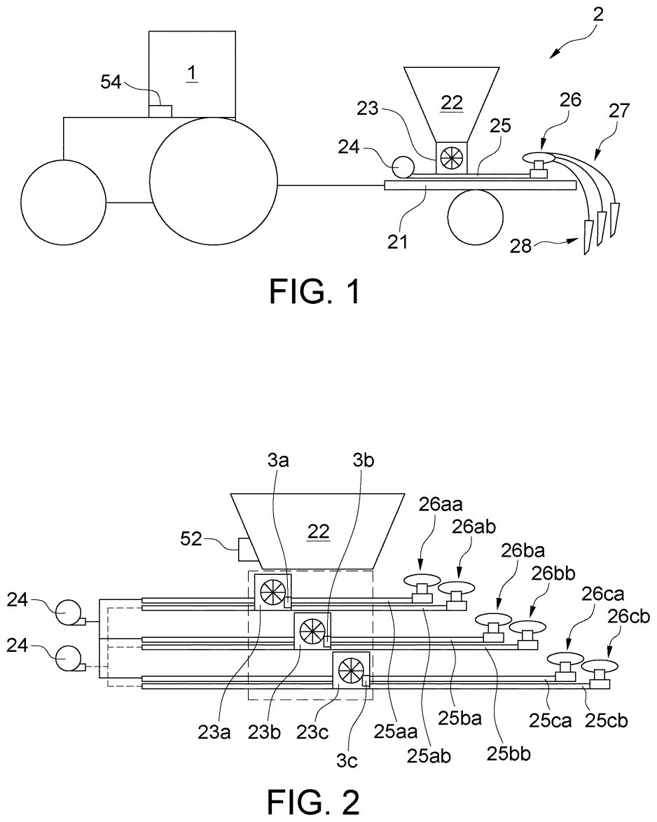

(a) FIG. 1 is a schematic view of an agricultural implement.

(b) FIG. 2 is a schematic illustration of an agricultural implement with a number of primary channels and distributors.

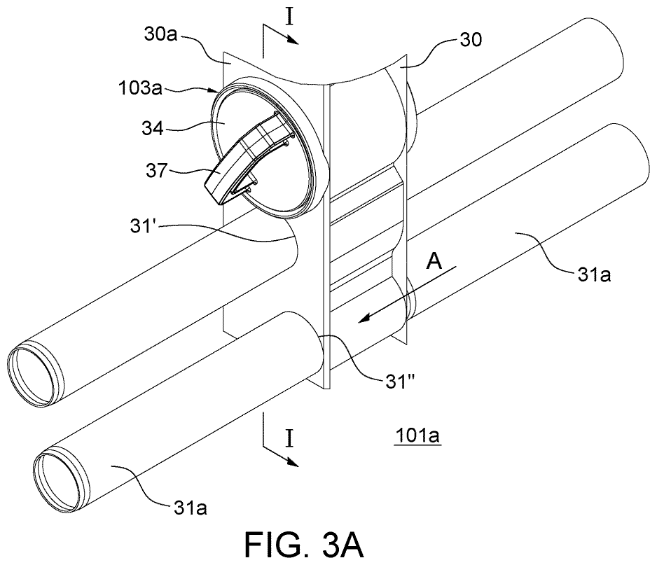

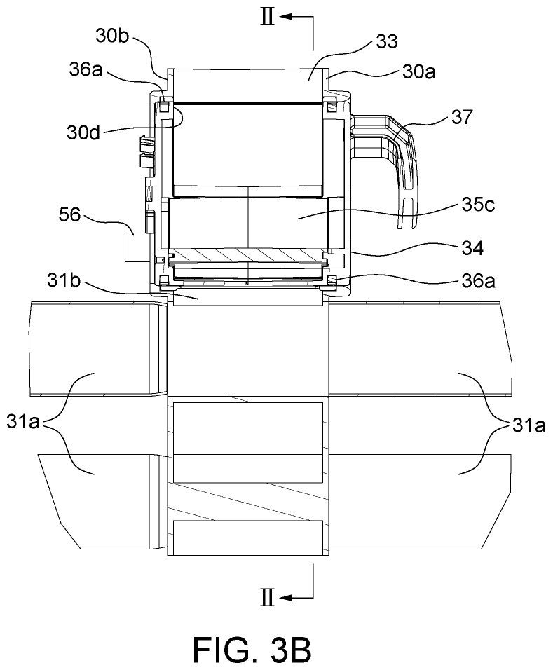

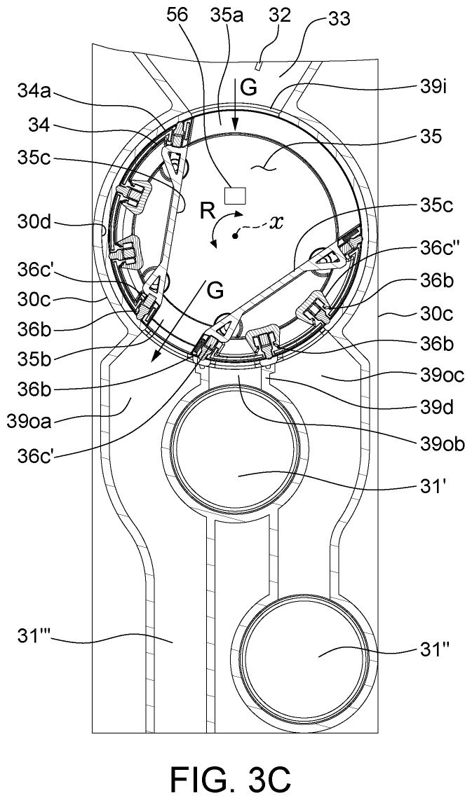

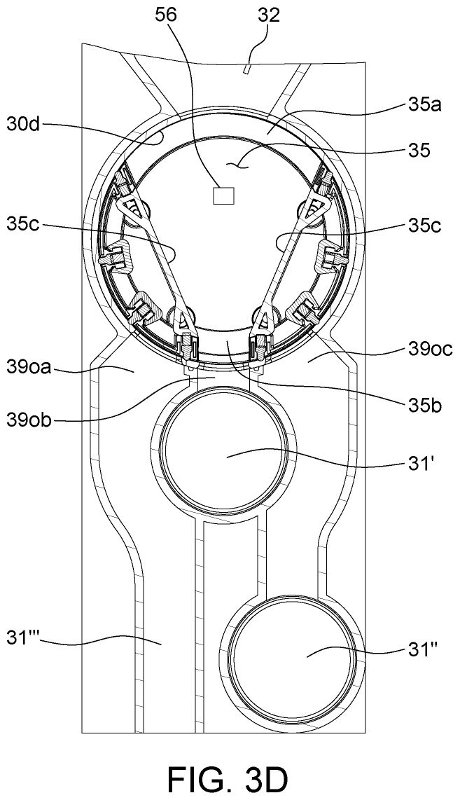

(c) FIGS. 3a-3d are views of a feeder assembly including an air stream selector, wherein FIG. 3a is a side perspective view of the feeder assembly, FIG. 3b is a sectional view along line I-I of FIG. 3a, FIG. 3c is a sectional view along line II-II, from side to side, of the feeder assembly of FIG. 3b with the air stream selector drum in one position and FIG. 3d is a sectional view similar to FIG. 3c but with the drum in a different position.

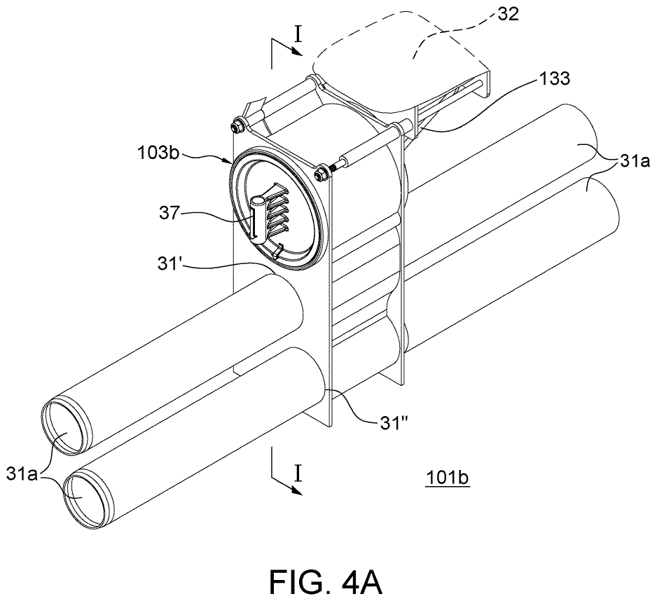

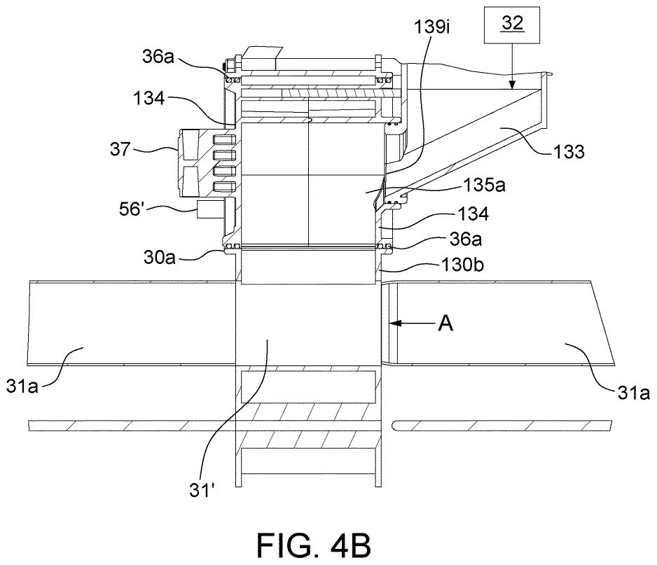

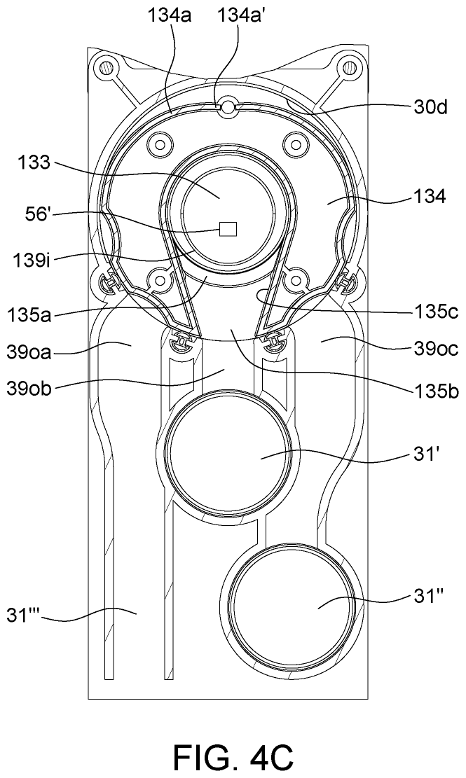

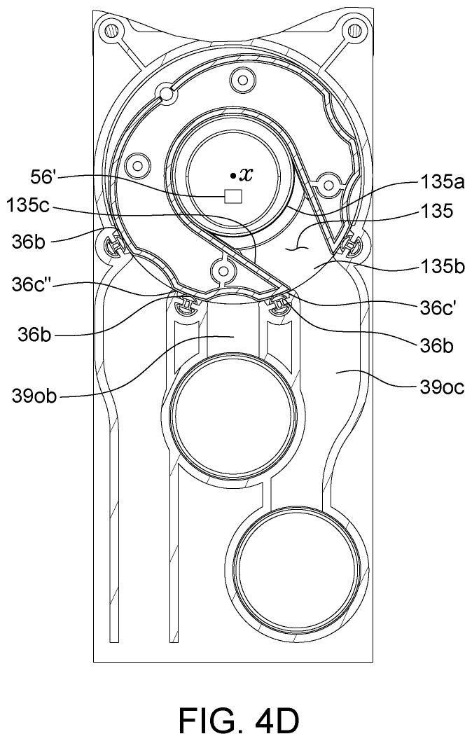

(d) FIGS. 4a-4c are views of another air stream selector in a feeder assembly, wherein FIG. 4a is a side perspective view, FIG. 4b is a sectional view from front to back of the feeder assembly of FIG. 4a, FIG. 4c is a sectional view from side to side the feeder assembly of FIG. 4a with the air stream selector drum in one position and FIG. 4d is a sectional view similar to FIG. 4c but with the drum in a different position.

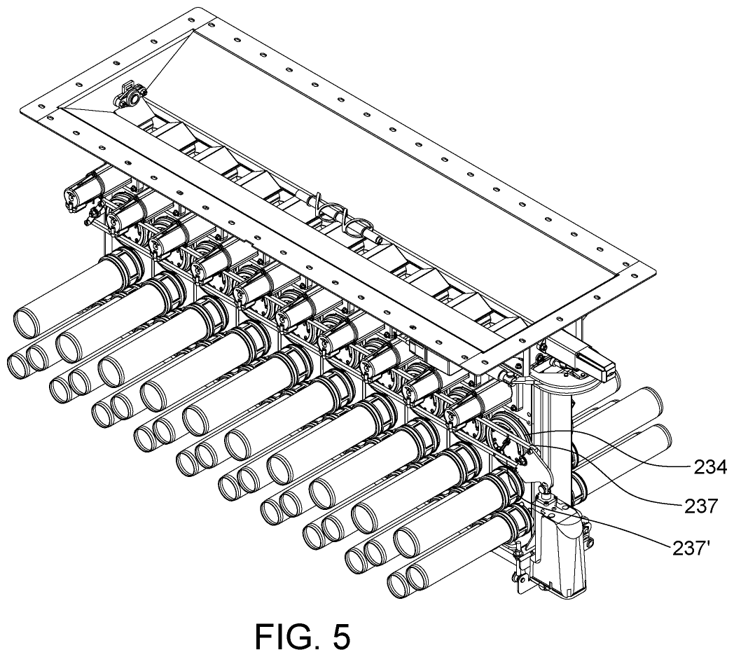

(e) FIG. 5 is a perspective view of a feeder assembly including a drive mechanism having a shaft coupled to a drum, according to one embodiment of the present invention.

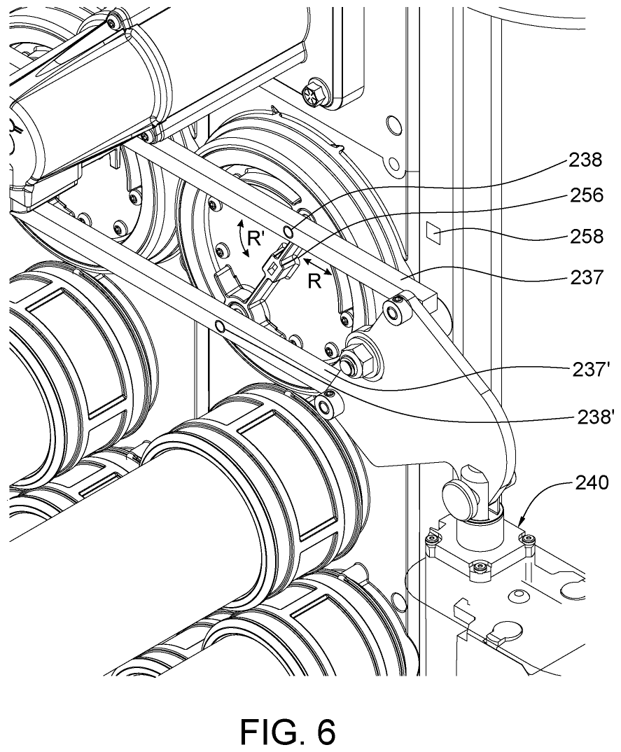

(f) FIG. 6 is a close-up view of a portion of the drive mechanism of FIG. 5.

### DETAILED DESCRIPTION

FIG. 1 shows an agricultural field assembly comprising a towing vehicle 1 and an agricultural implement 2, which can be a sowing machine.

The agricultural implement comprises a frame 21 and a container 22 for material to be distributed to the ground over which the agricultural implement travels. Below the container 22 is a meter 23, for feeding the material from the container 22. A fan 24 generates an air stream in a primary air flow channel 25. The meter 23 feeds the material from the container 22 to the primary channel 25, whereby the air stream flowing in the primary channel 25 carries the material to a material outlet 28, which is illustrated here as a ground-engaging tool.

In some embodiments, there may be a distribution unit 26 between the primary channel and the material outlet 28. Where there is a distribution unit 26, there may be a number of secondary channels 27 running from the distribution unit, each leading to a respective material outlet 28.

It is understood that the agricultural implement may comprise several frame sections, which may be movable relative to each other, and there may be a plurality of each of the material containers 22, meters 23, primary channels 25, distributors 26, sets of secondary channels 27 and ground engaging tools 28. The material containers may also be mounted on a separate detachable frame from the ground engaging tools.

FIG. 2 schematically shows a more typical modern feeding system for an agricultural implement, where three meters 23a, 23b, 23c are arranged to receive material from a container 22. Each meter feeds into two or more primary air flow channels. For example, meter 23a feeds to two air flow channels 25aa, 25ab, meter 23b feeds to two air flow channels 25ba, 25bb and meter 23c feeds to two air flow channels 25ca, 25cb. Each feeder 23a, 23b, 23c can be arranged to feed to further air flow channels or to feed to a bypass.

The air flow channels eventually lead to material outlets, but here are shown leading to distributors 26aa, 26ab, 26ba, 26bb, 26ca, 26cb, from which the material is conveyed via a respective set of secondary channels (not shown) to a respective set material outlets.

Air flow in the primary channels 25aa, 25ab, 25ba, 25bb, 25ca, 25cb can be generated by a common fan 24, by separate fans, or by one fan per material type (as shown in FIG. 2). With reference to FIG. 2, a first fan can thus create air flow in the primary channels 25aa, 25ba, 25ca and a second fan can create air flow in the primary channels 25ab, 25bb, 25cb.

An air stream selector 3a, 3b, 3c can be used to determine to which of the two primary channels respectively the flow from a specific meter is to be fed. For example, there is an air stream selector 3a between meter 23a and the two air flow channels 25aa, 25ab to which it feeds. Likewise, air steam selector 3b acts between meter 23b its two air flow channels 25ba, 25bb and air stream selector acts between meter 23c and its two air flow channels 25ca, 25cb.

Each air stream selector acts as a valve and has the function of controlling material fed from the meter with which it is in communication to a selected one of the air flow channels receiving material from that meter. Each air stream selector 3a, 3b, 3c can also be configured to direct flows to further air flow channels or to a bypass.

When using a plurality of meters and an air stream selector associated with each meter, an air stream selector assembly can be provided, where air stream selectors can be controlled individually or in combination. By controlling in combination, they can simultaneously be set to feed to a selected one of the corresponding primary channels, or so that they can be simultaneously set for bypass.

An example air stream selector 103a is shown in FIGS. 3a-3d in a feeder assembly 101a and another embodiment of a feeder assembly 101b with an air stream selector 103b is shown in FIGS. 4a-4d.

Referring to FIG. 3a-3d, air stream selector 103a is positioned within a feeder assembly and is positioned between a meter 32 and a plurality of air flow channels 31′, 31″ and a bypass channel 31′″.

It is to be understood that a direction of air flow through the air flow channels will be along the long axis of that air flow channel (arrow A). The air flow channels 31′, 31″ are hollow openings, such as cylinders, with open ends. Pipes 31a are connected upstream and downstream to the air flow channels to convey the air stream and granular material, to and from respectively, the air flow channels.

There may also be one or more bypass chutes 31′″ that may be used for bypass when emptying the container or when calibrating the meters.

While the air flow channels 31′, 31″ are illustrated as being oriented generally one above the other, the air flow channels can be arranged in other ways, for example, generally side by side.

An inlet chute 33 extends from meter 32 to air stream selector 103a. Granular materials from a hopper above meter 32 can pass through meter 32 and transfer chute 33 to enter air stream selector 103a.

The air stream selector has a housing 30 that defines front and back walls 30a, 30b and side walls 30c. The housing further defines an interior chamber 30d, an inlet 39i to chamber 30d and outlet chutes 390a, 39ob, 39oc from the interior chamber.

Inlet 39i opens into chamber 30d and outlet chutes 390a, 39ob, 39oc extend away from chamber 30d. In one embodiment, chamber 30d is a cylindrical area defined within substantially cylindrical interior walls of the housing and the inlet 39i and outlet chutes 390a, 39ob, 39oc all access the chamber through the side walls. In this illustrated embodiment, inlet 39i is positioned above, as determined by gravity the outlet chutes. Each outlet chute 390a, 39ob, 39oc leads to and is in communication with one of the air flow channels 31′, 31″ or the bypass chute 31′″. For example, outlet chute 390a extends from chamber 30d to become the bypass chute 31′″ and outlet chute 39ob extends from chamber 30d to the air channel 31′. Each outlet chute is separated from an adjacent outlet chute by a partition wall 39d that terminates at the chamber 30d.

Air stream selector 103a further includes a drum 34 installed in interior chamber 30d. Drum 34 acts as a valve in chamber 30d to control movement of granular materials along a direction of flow from inlet 39i to outlet chutes 390a, 39ob, 39oc. Since the air flow selector is mainly based on gravity, the direction of flow (arrow G) through the chamber is primarily vertically.

Drum 34 is rotatable in chamber 30d about an axis x that is coaxial with the center axis of the cylindrical chamber and is substantially orthogonal to the direction of flow of the granular material out through chutes 390a, 39ob, 39oc. In particular, drum 34 is generally configured to rotate (arrow R) about a horizontal axis.

Drum 34 is substantially cylindrical with substantially cylindrical outer walls 34a about axis X. The rotating drum includes a channel 35 extending as a passage through the body of the drum from an inlet opening 35a to an outlet opening 35b. Outlet opening 35b is sized to only align with one outlet chute at a time. Channel 35 provides a passageway through the rotating drum 34 to provide for granular material to move through the drum from inlet 39i to a selected one of outlet chutes 390a, 39ob, 39oc.

Like a dial, drum 34 can be rotated about axis x such that the outlet opening 35b aligns with any one of outlet chutes 390a, 39ob, 39oc. Thereby, any granular material passing through channel 35 is directed to enter only that one selected outlet chute. Inlet opening 35a is wide and therefore large enough that it is always be open to inlet 39i, regardless of which outlet chute the outlet opening 35b is aligned with.

In the illustrated embodiment of FIGS. 3a-3d, channel 35 is defined by a pair of deflector plates 35c that extend along the length of the drum, the length being defined by the axis x. The plates 35c converge from inlet opening 35a to outlet opening 35b. Therefore, channel 35 in the illustrated embodiment is funnel-shaped, tapering from channel inlet to the channel outlet and extending substantially diametrically from side to side of the drum.

Seals may be provided to retain air pressure in the air stream selector. For example, seals may be provided at possible leak points through the housing. In one embodiment, one or both ends of drum 34 pass through the housing. In such an embodiment, there may be rotary seals 36a between the drum and the housing. Rotary seals 36a can accommodate rotation between the parts and retain a seal against air leakage about the circumference of the drum, for example, at its ends. The seals may be retained within the drum or they may be retained in the housing.

In addition or alternatively, there may be seals between the drum and the outlet chutes to seal against flows from chute to chute. In one embodiment, there are seals 36b extending along the sides of each outlet chute 390a, 39ob, 39oc, where they open into chamber 30d and ribs 36c', 36c“ on the drum that are configured to align with and bear against seals 36b. Seals 36b may, for example, extend along the terminal end of each partition wall 39d. There may be a rib 36c′ extending at the outlet opening edge of each deflection plate 35c. There may be a further ribs 36c” spaced around the cylindrical wall 34a a distance corresponding to the distance from side to side of the chutes to be sealed. The seals 36b may alternatively be carried on the drum exterior wall, if desired.

Drum 34 may be rotated by various means, such as manually or via a drive mechanism.

Drum 34 may include a handle 37 on an end that is accessible from outside the housing. Handle 37 may be useful for grasping and rotating the drum. The orientation of the handle, for example with a long part thereof, aligned along a direction from inlet opening 35a to outlet opening 35b, may be useful to provide a visual indication, like a dial face, indicating the chute with which the outlet opening is aligned.

In one embodiment, drum 34 is configured to be removable from housing 30. For example, drum 34 may be configured to be removable by axially sliding out of chamber 30d, for example through front or back walls 30a, 30b. This may facilitate work on the feeder assembly, air stream selector 103a and drum 34, for example maintenance or replacement of the drum.

The air stream selector 103b of FIGS. 4a-4d is similar to that of FIGS. 3a-3d, except with respect to the inlet of granular material to the drum 134. While in FIGS. 3a-3d the inlet 39i to housing is at an upper end of air stream selector 103a, inlet 139i in the feeder assembly of FIG. 4a is at a back wall 130b. The transfer chute 133 from meter 32 couples to the drum 134 on its end wall at the back wall 130b of the housing.

In this embodiment, inlet opening 135a to channel 135 is therefore at an end of drum 134. The inlet 139i to housing and inlet opening 135a can be arranged to be coaxial with the drum, so that the drum rotates about its coupling to chute 133. As such, the granular material enters drum 134 at its center along axis x.

Outlet opening 135b remains on the cylindrical wall of drum and channel 135 extends from opening 135a to opening 135b. The walls 135c can converge from opening 135a to opening 135b to form a funnel-type structure.

The outer wall 134a of drum 134 in FIGS. 4c, 4d may be selected to have a flattened or indented upper portion 134a'. This provides an area of clearance between the drum and the housing to reduce friction and to improve drum rotation.

The air stream selectors 103a, 103b may be operated to pass granular material from the meter into a selected air stream channel. This is done by rotating the drum 34, 134 within the housing to align the outlet opening 35b, 135b over one of the outlet chutes 390a, 39ob, 39oc. Regardless of the rotational position of the drum in the housing, inlet opening 35a, 135a due to its width or concentricity remains aligned with the inlet chute 33, 133 from meter 32 to receive granular materials from the meter. Further, the drum's outer cylindrical walls remain close to the housing chamber interior walls in all positions and need only move rotationally within the chamber, thus the incoming material tends not to collect or block movements of the drum within the air selector.

A sensor, such as sensor 56 (FIGS. 3b), 56′ (FIGS. 4b), 256 (FIG. 6), e.g., one or more of a position sensor, a limit switch, a mechanical sensor (such as a microswitch), a resistive sensor (such as a potentiometer), an optical sensor (such as a refracted light beam sensor), a proximity sensor, a laser distance sensor, a hall sensor, a presence sensor, etc., may be configured to detect the position of the drum, and communicate the sensed position to a processor 52. The same sensor, or another position sensor, may sense whether the drum is properly installed in the air stream selector. In embodiments with multiple drums, each drum may be monitored independently.

The processor can verify whether the drum is in the expected or intended position, or alternatively that the shaft and/or the drum are in unexpected position(s), which could indicate that a failure or pre-failure event has occurred. For example, the drum could be jammed by material such that the drum cannot effectively move between positions. If an unexpected position is detected, the processor may cause an alert to be communicated to a user, e.g., via a user interface 54 (which may include a screen in vehicle 1). Further, or alternatively, if an unexpected position is detected, the processor may cause the apparatus to stop, which may advantageously prevent wear, and may further advantageously conserve material being distributed via the agricultural implement.

As noted previously, the drum may be rotated by various means, such as via a drive mechanism. The drive mechanism may facilitate selecting moving the drum between positions. For example, a user in vehicle 1 may input a desired drum position into a user interface, which may, via a processor, instruct the drive mechanism to move the drum to the desired drum position.

The drive mechanism may include a shaft coupled to the drum. For example, with reference to FIGS. 5 and 6, a shaft 237 may be coupled to a drum 234. The shaft may be able to rotate the drum between positions within the housing. The shaft may extend perpendicular to the long axis of the drum. The shaft may be coupled to the drum at a connection 238, which may be positioned off centre from the axis of rotation of the drum, being axis x of the drum, e.g., on the end wall of the drum close to its outer cylindrical wall. The connection may be a member that extends from the housing to the shaft and may be rotatable with respect to, e.g., within, the shaft and/or the drum. The shaft may be movable back and forth in a direction R perpendicular to the long axis of the drum, i.e., parallel to the axis of the shaft. As shaft 237 moves back and forth, it causes the drum to rotate via connection 238. Accordingly, the shaft may be configured to accommodate some vertical movement as it causes connection 238 to move along an arcuate path thereby driving the drum between positions. The shaft may be driven by a motor 240.

There may be a second shaft 237′ coupled to the drum 234 via a second connection 238′, e.g., at a position on the drum diametrically opposite to the position on the drum of the first connection 238.

The second shaft may be driven by a motor, e.g., motor 240. In such an embodiment, it is to be appreciated that the motor may cause the shafts to move in opposite directions, such that the drum moves between positions along arrow R′, i.e., either clockwise or counterclockwise, as the case may be.

In embodiments with a plurality of drums, the drums may be arranged side by side and the shaft may be coupled to a plurality of drums, as illustrated in FIG. 5.

The drive mechanism may be in communication with processor 52, which may be configured to monitor and/or command the movement of the drum, e.g., via the shaft.

A sensor 56 (FIGS. 3b), 56′ (FIGS. 4b), 256 (FIG. 6), may be configured to detect the position of the drum and/or the shaft, and communicate the sensed position(s) to the processor. In one embodiment, the position sensor may sense strokes of the shaft. The same sensor, or another position sensor, may sense whether the drum is properly installed in the air stream selector. In embodiments with multiple drums, each drum may be monitored independently.

The processor can verify whether the shaft and/or the drum are in the expected or intended positions, or alternatively that the shaft and/or the drum are in unexpected position(s), which could indicate that a failure or pre-failure event has occurred. If an unexpected position is detected, the processor may cause an alert to be communicated to a user, e.g., via a user interface 54 (which may include a screen in vehicle 1). Further, or alternatively, if an unexpected position is detected, the processor may cause the motor to stop, which may advantageously prevent wear on the motor, shaft, drum, and other components engaged therewith, and may further advantageously conserve material being distributed via the agricultural implement.

Further, or in the alternative, a load sensor may be configured to measure load (e.g., one or more of electrical load, current draw, heat, torque, etc.) on the motor, and the processor may receive and analyze such load measurements. Abnormal load measurements may indicate that the shaft is being met with unexpected resistance, which could indicate a failure or pre-failure event. If the processor receives an abnormal load measurement, e.g., if load exceeds a pre-determined acceptable threshold, the processor may cause an alert to be communicated to the user, e.g., via user interface 54, and/or may cause the motor to stop.

A speed sensor 258 may be configured to monitor a speed of the shaft. Abnormal speed measurements (e.g., if the shaft is not moving or is moving slower than expected after the processor has instructed the shaft to move the drum between positions) may indicate a failure or pre-failure event. If the processor receives an abnormal speed measurement, the processor may cause an alert to be communicated to the user and/or may cause the motor to stop.

Any one or more of the measurements may be communicated to the user, e.g., via the user interface, such that the user may monitor performance. The processor may record data over time and use such data to determine whether a failure event has occurred. The processor may cause an alert to the user to suggest maintenance, or the processor may automatically schedule such maintenance, or the processor may cause certain preventative action (e.g., lubrication) to occur.

The processor may receive user commands from the user via the user interface. For example, the user may indicate a desired position for the shaft (and thereby, the drum) to the user interface, which may be communicated as a signal to the processor, and the processor may cause the motor to drive the shaft and the drum to the desired position.

### Clauses

Clause 1. An air stream selector comprising: a material inlet; a first material outlet chute and a second material outlet chute, the first and second material outlet chutes being in communication with first and second air flow channels, respectively; and an air stream selector drum positioned between the material inlet and the first and second material outlet chutes, the drum being rotatable about an axis and including a channel therethrough, the channel including an inlet end and an outlet end, the outlet end configured to be alignable with only a selected one of the first material outlet chute and the second material outlet chute, while the inlet end remains in communication with the material inlet.

Clause 2. The air stream selector of any one or more of clauses 1-20 wherein the inlet opening of the channel is positioned on a cylindrical side wall of the air stream selector drum.

Clause 3. The air stream selector of any one or more of clauses 1-20 wherein the inlet opening of the channel is coaxial with the axis of the air stream selector drum.

Clause 4. The air stream selector of any one or more of clauses 1-20 further comprising: a rotary seal between the air stream selector drum and a housing of the air stream selector configured to seal against leakage from the housing.

Clause 5. The air stream selector of any one or more of clauses 1-20 further comprising: seals between the air stream selector drum and the first material outlet chute and the second material outlet chute.

Clause 6. The air stream selector of any one or more of clauses 1-20 wherein the drum is removable by axially sliding through an opening in a housing of the air stream selector.

Clause 7. The air stream selector of any one or more of clauses 1-20 further comprising a third material outlet chute adjacent the second material outlet chute and the outlet end of the air stream selector drum channel is configured to be alignable with only a selected one of the first material outlet chute, the second material outlet chute or the third material outlet chute, while the inlet end remains in communication with the material inlet.

Clause 8. The air stream selector of any one or more of clauses 1-20, further comprising: a sensor configured to detect a position of the drum and communicate the sensed position to a processor.

Clause 9. The air stream selector of any one or more of clauses 1-20, further comprising: a drive mechanism for rotating the air stream selector drum to selectably align the outlet end with one of the first material outlet chute and the second material outlet chute; and a processor for monitoring and commanding the drive mechanism.

Clause 10. The air stream selector of any one or more of clauses 1-20, wherein: the drive mechanism includes a shaft coupled to the drum at a connection on an end wall of the drum between the axis of the drum and an outer cylindrical wall of the drum, the shaft extending perpendicular to the axis of the drum, the shaft being drivable to cause the connection between the shaft and the drum to move along an arcuate path and thereby rotate the drum, a motor coupled to the shaft, the shaft being drivable by the motor; and the processor is configured to direct the motor to drive the shaft and thereby selectively align the outlet.

Clause 11. The air stream selector of any one or more of clauses 1-20, further comprising a sensor configured to sense the position of the drum and communicate the sensed position to the processor.

Clause 12. The air stream selector of any one or more of clauses 1-20, further comprising a user interface for receiving a desired position and communicating the desired position to the processor to cause the motor to drive the shaft to the desired position.

Clause 13. The air stream selector of any one or more of clauses 1-20, further comprising a load sensor configured to measure load on the motor, wherein the processor is configured to receive the load measurement from the load sensor.

Clause 14. The air stream selector of any one or more of clauses 1-20, wherein the processor is configured to communicate an alert to a user interface if an abnormal load measurement is received from the load sensor.

Clause 15. The air stream selector of any one or more of clauses 1-20, wherein the processor is configured to stop the motor if an abnormal load measurement is received from the load sensor.

Clause 16. The air stream selector of any one or more of clauses 1-20, further comprising a speed sensor configured to measure a speed of the shaft, wherein the processor is configured to receive the speed measurement from the speed sensor.

Clause 17. The air stream selector of any one or more of clauses 1-20, wherein the processor is configured to communicate an alert to a user interface if an abnormal speed measurement is received from the speed sensor.

Clause 18. The air stream selector of any one or more of clauses 1-20, wherein the processor is configured to stop the motor if an abnormal speed measurement is received from the speed sensor.

Clause 19. An agricultural implement comprising: a hopper for granular material; a meter for receiving granular material from the hopper; and the air stream selector of any one or more of clauses 1-20 in communication with an output of the meter.

Clause 20. A method for distributing granular material in an agricultural implement, the method comprising: passing the granular material from a meter to an air stream selector according to any one or more of clauses 1-20, rotating the air stream selector drum about the axis to align the outlet end of the channel with only a selected one of the first material outlet chute and the second material outlet chute to distribute the granular material to either the first air flow channel via the first material outlet chute or the second air flow channel via the second material outlet chute.

While the invention has been described in conjunction with the disclosed embodiments, it will be understood that the invention is not intended to be limited to these embodiments. On the contrary, the invention is intended to cover alternatives, modifications and equivalents, which may be included within the spirit and scope of the invention. Various modifications will remain readily apparent to those skilled in the art, based on the generic principles of the present invention that have been defined herein.

1. An air stream selector comprising:
a material inlet;
a first material outlet chute and a second material outlet chute, the first and second material outlet chutes being in communication with first and second air flow channels, respectively; and
an air stream selector drum positioned between the material inlet and the first and second material outlet chutes, the drum being rotatable about an axis and including a channel therethrough, the channel including an inlet end and an outlet end, the outlet end configured to be alignable with only a selected one of the first material outlet chute and the second material outlet chute, while the inlet end remains in communication with the material inlet.

2. The air stream selector of claim 1 wherein the inlet opening of the channel is positioned on a cylindrical side wall of the air stream selector drum.

3. The air stream selector of claim 1 wherein the inlet opening of the channel is coaxial with the axis of the air stream selector drum.

4. The air stream selector of claim 1 further comprising: a rotary seal between the air stream selector drum and a housing of the air stream selector configured to seal against leakage from the housing.

5. The air stream selector of claim 1 further comprising: seals between the air stream selector drum and the first material outlet chute and the second material outlet chute.

6. The air stream selector of claim 1 wherein the drum is removable by axially sliding through an opening in a housing of the air stream selector.

7. The air stream selector of claim 1 further comprising a third material outlet chute adjacent the second material outlet chute and the outlet end of the air stream selector drum channel is configured to be alignable with only a selected one of the first material outlet chute, the second material outlet chute or the third material outlet chute, while the inlet end remains in communication with the material inlet.

8. The air stream selector of claim 1, further comprising:
a sensor configured to detect a position of the drum and communicate the sensed position to a processor.

9. The air stream selector of claim 1, further comprising:
a drive mechanism for rotating the air stream selector drum to selectably align the outlet end with one of the first material outlet chute and the second material outlet chute; and
a processor for monitoring and commanding the drive mechanism.

10. The air stream selector of claim 9, wherein:
the drive mechanism includes a shaft coupled to the drum at a connection on an end wall of the drum between the axis of the drum and an outer cylindrical wall of the drum,
the shaft extending perpendicular to the axis of the drum,
the shaft being drivable to cause the connection between the shaft and the drum to move along an arcuate path and thereby rotate the drum,
a motor coupled to the shaft, the shaft being drivable by the motor; and
the processor is configured to direct the motor to drive the shaft and thereby selectively align the outlet.

11. The air stream selector of claim 9, further comprising a sensor configured to sense the position of the drum and communicate the sensed position to the processor.

12. The air stream selector of claim 9, further comprising a user interface for receiving a desired position and communicating the desired position to the processor to cause the motor to drive the shaft to the desired position.

13. The air stream selector of claim 9, further comprising a load sensor configured to measure load on the motor, wherein the processor is configured to receive the load measurement from the load sensor.

14. The air stream selector of claim 13, wherein the processor is configured to communicate an alert to a user interface if an abnormal load measurement is received from the load sensor.

15. The air stream selector of claim 13, wherein the processor is configured to stop the motor if an abnormal load measurement is received from the load sensor.

16. The air stream selector of claim 9, further comprising a speed sensor configured to measure a speed of the shaft, wherein the processor is configured to receive the speed measurement from the speed sensor.

17. The air stream selector of claim 16, wherein the processor is configured to communicate an alert to a user interface if an abnormal speed measurement is received from the speed sensor.

18. The air stream selector of claim 16, wherein the processor is configured to stop the motor if an abnormal speed measurement is received from the speed sensor.

19. An agricultural implement comprising:
a hopper for granular material;
a meter for receiving granular material from the hopper; and
the air stream selector of claim 1 in communication with an output of the meter.

20. A method for distributing granular material in an agricultural implement, the method comprising: passing the granular material from a meter to an air stream selector according to claim 1, rotating the air stream selector drum about the axis to align the outlet end of the channel with only a selected one of the first material outlet chute and the second material outlet chute to distribute the granular material to either the first air flow channel via the first material outlet chute or the second air flow channel via the second material outlet chute.
